(19) United States
(12) Patent Application Publication
(10) Pub. No.: US 2024/0120524 A1
(43) Pub. Date: Apr. 11, 2024

(54) BATTERY AND METHOD FOR PRODUCING BATTERY

(71) Applicant: TDK CORPORATION, Tokyo (JP)

(72) Inventors: Tetsuya UENO, Tokyo (JP); Takamasa MUKAI, Tokyo (JP); Wen MA, Tokyo (JP)

(73) Assignee: TDK CORPORATION, Tokyo (JP)

(21) Appl. No.: 18/276,319

(22) PCT Filed: Mar. 1, 2022
(86) PCT No.: PCT/JP2022/008644

§ 371 Date: Aug. 8, 2023

(30) Foreign Application Priority Data
Mar. 1, 2021 (JP) 2021-031357

(51) Int. Cl. H01M 10/04; H01M 10/052

(52) U.S. Cl. CPC H01M 10/0481; H01M 10/052; H01M 2300/0065

(57) ABSTRACT

Provided is a battery including a battery element having a positive electrode, a negative electrode, and a solid electrolyte layer between the positive electrode and the negative electrode, and further including an exterior body covering the battery element, in which at least one of the positive electrode, the negative electrode, and the solid electrolyte layer includes a solid electrolyte represented by Formula (1) of Li₃₊ₐE_{1-b}G_{b}D_{c}X_{d-e}, and a moisture content in a housing space between the battery element and the exterior body is less than 1100 ppmv.

### TECHNICAL FIELD

The present invention relates to a battery and a method for producing a battery.

Priority is claimed on Japanese Patent Application No. 2021-031357 filed on Mar. 1, 2021, the content of which is incorporated herein by reference.

### BACKGROUND ART

In recent years, developments in electronics technology have been remarkable, and portable electronic devices have become smaller and lighter, thinner, and more multifunctional. Along with that, there is a strong demand for batteries serving as power sources of electronic devices to be smaller and lighter, thinner, and more reliable, and all-solid-state batteries using a solid electrolyte as an electrolyte have attracted attention.

As examples of a method for manufacturing an all-solid-state battery, there are a sintering method and a powder molding method. In the sintering method, a negative electrode, a solid electrolyte layer, and a positive electrode are laminated and then sintered to form an all-solid-state battery. In the powder molding method, a negative electrode, a solid electrolyte layer, and a positive electrode are laminated, and then a pressure is applied to form an all-solid-state battery. Materials that can be used for a solid electrolyte layer differs according to the manufacturing method. As solid electrolytes, oxide-based solid electrolytes, sulfide-based solid electrolytes, complex hydride-based solid electrolytes (such as LiBH₄), and the like are known.

Patent Document 1 discloses a solid electrolyte secondary battery including a positive electrode, a negative electrode, and a solid electrolyte formed of a compound represented by a general formula Li₃₋₂ₓMₓIn_{1-Y}M′_{Y}L_{6-Z}L′Z. In the general formula described above, M and M′ are metal elements, and L and L′ are halogen elements. Also, X, Y, and Z independently satisfy 0≤X<1.5, 0≤Y<1, and 0≤Z≤6. Also, the positive electrode includes a positive electrode layer containing a positive electrode active material containing the element Li, and a positive electrode current collector. Also, the negative electrode includes a negative electrode layer containing a negative electrode active material, and a negative electrode current collector.

Patent Document 2 discloses a solid electrolyte material represented by the following compositional formula (1).

Li_{6-3Z}Y_{Z}X₆ Formula (1)

Here, 0≤Z<2 is satisfied, and X is Cl or Br.

Also, Patent Document 2 describes a battery in which at least one of a negative electrode and a positive electrode contains the solid electrolyte material.

Patent Document 3 describes an all-solid-state battery including an electrode active material layer having a first solid electrolyte material and a second solid electrolyte material. The first solid electrolyte material is a single-phase electron-ion mixed conductor, and is a material having an active material and an anion component that is in contact with the active material and different from an anion component of the active material. The second solid electrolyte material is an ion conductor that is in contact with the first solid electrolyte material, has the same anion component as that of the first solid electrolyte material, and does not have electron conductivity. The first solid electrolyte material is Li₂ZrS₃.

### CITATION LIST

### Patent Document

[Patent Document 1]
Japanese Unexamined Patent Application, First Publication No. 2006-244734

[Patent Document 2]
PCT International Publication No. WO 2018/025582

[Patent Document 3]
Japanese Unexamined Patent Application, First Publication No. 2013-257992

### SUMMARY OF INVENTION

### Technical Problem

However, there have been cases in which a sufficient charge/discharge efficiency could not be obtained in any of the solid electrolytes described in Patent Documents 1 to 3.

The present invention has been made in view of the above-described problems, and an objective of the present invention is to provide a battery with a high charge/discharge efficiency and a method for producing the same.

### Solution to Problem

The present inventors have conducted intensive research to solve the above-described problems. As a result, it has been found that deterioration of a current collecting function due to corrosion of a metal portion in an all-solid-state battery serves as one of the factors that reduce the charge/discharge efficiency of the battery. Then, it has been found that moisture contained in a housing space contributes to occurrence of corrosion of the metal portion. That is, the following means are provided to solve the above-described problems.
(1) A battery according to a first aspect includes a battery element having a positive electrode, a negative electrode, and a solid electrolyte layer between the positive electrode and the negative electrode, in which at least one of the positive electrode, the negative electrode, and the solid electrolyte layer includes a solid electrolyte represented by the following Formula (1).

Li₃₊ₐ₋ₑE_{1-b}G_{b}D_{c}X_{d-e} (1)

In Formula (1), E is at least one element selected from the group consisting of Al, Sc, Y, Zr, Hf, and lanthanoids, G is at least one element selected from the group consisting of Na, K, Rb, Cs, Mg, Ca, Sr, Ba, B, Si, Al, Ti, Cu, Sc, Y, Zr, Nb, Ag, In, Sn, Sb, Hf, Ta, W, Au, and Bi, D is at least one selected from the group consisting of CO₃, SO₄, BO₃, PO₄, NO₃, SiO₃, OH, and O₂, X is at least one element selected from the group consisting of F, Cl, Br, and I, and when n=(valence of E)−(valence of G), a=nb, 0≤b<0.5, 0≤c≤5, 0≤d≤7.1, 0≤e≤2, and 0<d-e are satisfied. Also, the battery according to the first aspect further includes an exterior body covering the battery element, in which a moisture content in a housing space between the battery element and the exterior body is less than 1100 ppmv.
(2) In the battery according to the above-described aspect, a moisture content in the housing space may be 600 ppmv or less.
(3) A method for producing a battery includes an element manufacturing step of sandwiching a solid electrolyte layer between a positive electrode and a negative electrode and pressure-forming thereof to manufacture a battery element, and a housing step of housing the battery element in an exterior body, in which at least one of the positive electrode, the negative electrode, and the solid electrolyte layer includes a solid electrolyte represented by Formula (1) described above, and a dew point in the housing step is set to be lower than −20° C. and −90° C. or higher.

### Advantageous Effects of Invention

The battery according to the above-described aspect is excellent in charge/discharge efficiency.

### BRIEF DESCRIPTION OF DRAWINGS

FIG. 1 is a perspective view of an all-solid-state battery according to the present embodiment.

FIG. 2 is a cross-sectional view of the all-solid-state battery according to the present embodiment.

### DESCRIPTION OF EMBODIMENTS

Hereinafter, the present embodiment will be described in detail with reference to the drawings as appropriate. In the drawings used in the following description, there are cases in which characteristic portions are enlarged for convenience of illustration so that characteristics can be easily understood, and dimensional proportions of respective constituent elements may be different from actual ones. Also, materials, dimensions, and the like illustrated in the following description are merely examples, and the present invention is not limited thereto and can be implemented with appropriate modifications within a range not changing the gist of the present invention.

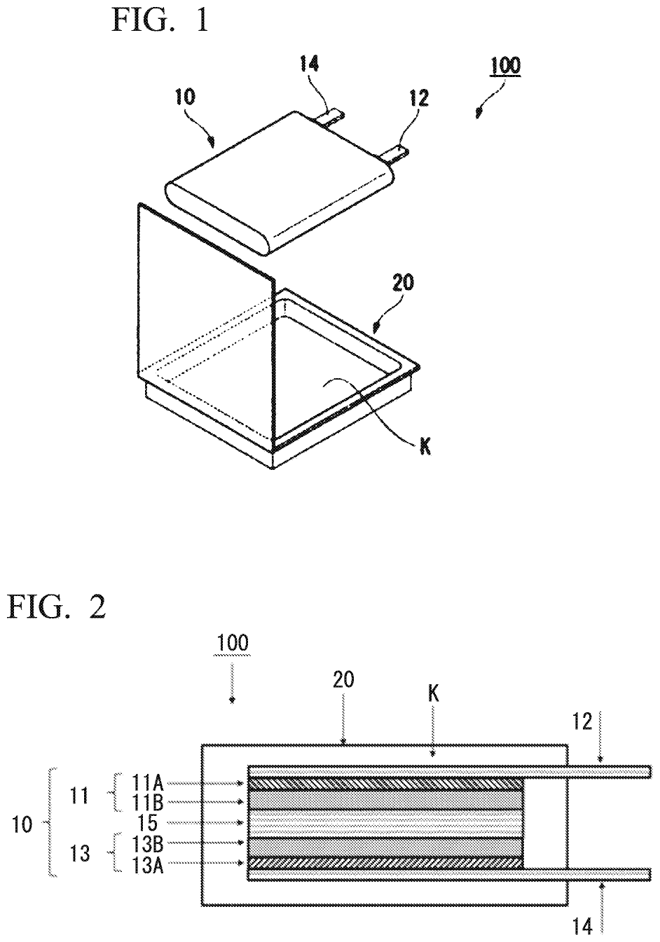

FIG. 1 is a perspective view of an all-solid-state battery 100 according to the present embodiment. The all-solid-state battery 100 illustrated in FIG. 1 includes a battery element 10 and an exterior body 20. The battery element 10 is housed in a housing space K inside the exterior body 20. For ease of understanding, FIG. 1 illustrates a state immediately before the battery element 10 is housed in the exterior body 20. The battery element 10 includes external terminals 12 and 14 electrically connected to the outside.

The exterior body 20 includes, for example, a metal foil 22 and a resin layer 24 laminated on both sides of the metal foil 22 (see FIG. 2). The exterior body 20 is a metal laminate film in which the metal foil 22 is coated with a polymer film (the resin layer 24) from both sides. The metal foil 22 is, for example, an aluminum foil. The resin layer 24 is, for example, a polymer film such as polypropylene. The resin layer 24 may be the same on both the inner and outer sides, or may be different. For example, a polymer with a high melting point such as, for example, polyethylene terephthalate (PET), and polyamide (PA) can be used as the outer resin layer, and polyethylene (PE), polypropylene (PP), polyvinyl chloride (PVC), a polytetrafluoroethylene (PTFE or TFE) resin, a fluoroethylene propylene (FEP) resin, a trifluoroethylene chloride (CI PE) resin, a vinylidene fluoride resin, polyimide, a perfluorinated alkoxy (PFA) resin, and the like which are high in heat resistance, oxidation resistance, reduction resistance, corrosion resistance, and weather resistance can be used as the inner resin layer. From the perspective of further improving the heat resistance, the oxidation resistance, the reduction resistance, the corrosion resistance, and the weather resistance, a resin layer obtained by forming two or more types of resins into a matrix shape or a resin layer having a multi-layer structure with two or more layers may be used.

FIG. 2 is a cross-sectional view of the all-solid-state battery 100 according to the present embodiment. The all-solid-state battery 100 includes a positive electrode 11 (positive electrode current collector 11A, positive electrode active material layer 11B), a negative electrode 13 (negative electrode current collector 13A, negative electrode active material layer 13B), a solid electrolyte layer 15, the external terminals 12 and 14, and the housing space K. The solid electrolyte layer 15 is, for example, between the positive electrode active material layer 11B and the negative electrode active material layer 13B. The battery element 10 includes the positive electrode current collector 11A/the positive electrode active material layer 11B/the solid electrolyte layer 15/the negative electrode active material layer 13B/the negative electrode active material layer 13A.

The all-solid-state battery 100 is charged or discharged by transfer of electrons via the positive electrode current collector 11A and the negative electrode current collector 13A and by transfer of lithium ions via the solid electrolyte layer 15. The all-solid-state battery 100 may be a laminated body in which the positive electrode 11, the negative electrode 13, and the solid electrolyte layer 15 are laminated, or a wound body thereof. The all-solid-state battery 100 is used for, for example, a laminate battery, a square battery, a cylindrical battery, a coin-type battery, a button-type battery, and the like.

It is preferable that a moisture content in the housing space K between the battery element 10 and the exterior body 20 be made, for example, less than 1100 ppmv from the perspective of suppressing generation of halogenated gas due to a reaction between a solid electrolyte and moisture. Suppression of halogenated gas can suppress deterioration of the current collecting function due to corrosion of metal portions (a current collector, a conductive auxiliary agent, a storage container, and the like) of the battery element 10 and reduce locally uneven electrochemical reactions, thereby improving a charge/discharge efficiency of the all-solid-state battery 100. The moisture content contained in the housing space K can be measured using, for example, a capacitive moisture meter, a Karl Fischer method, FTIR, GC/MS, tunable semiconductor laser light absorption spectroscopy, cavity ring-down spectroscopy, atmospheric pressure ionization mass spectrometry, or the like.

The moisture content in the housing space K between the battery element 10 and the exterior body 20 is, for example, 600 ppmv or less. This is preferable from the perspective of suppressing generation of halogenated gas due to a reaction between the solid electrolyte and moisture. Suppression of the halogenated gas can curb deterioration of the current collecting function due to corrosion of metal portions (a current collector, a conductive auxiliary agent, a storage container, and the like) of the battery element 10 and curb locally non-uniform electrochemical reactions, thereby further improving the charge/discharge efficiency of the all-solid-state battery 100.

If the moisture content in the housing space K between the battery element 10 and the exterior body 20 is large, generation of halogenated gas cannot be sufficiently suppressed, and the current collecting function deteriorates due to corrosion of metal portions (a current collector, a conductive auxiliary agent, a storage container, and the like) of the battery element 10, thereby forming a non-uniform flow of a current and ions. Thereby, locally non-uniform charge/discharge reactions occur, and the charge/discharge efficiency of the all-solid-state battery 100 decreases. Also, if the external terminals 12 and 14 are attached to the positive electrode current collector 11A or the negative electrode current collector 13A by welding, or the like, there is a likelihood that the welded part will corrode to cause a poor connection and detachment.

### “Solid Electrolyte Layer”

The solid electrolyte layer 15 contains a solid electrolyte. The solid electrolyte layer 15 contains a solid electrolyte represented by, for example, the following Formula (1).

Li₃₊ₐ₋ₑE_{1-b}G_{b}D_{c}X_{d-e} (1)

In the above-described Formula (1), E is a trivalent element. E is at least one element selected from the group consisting of, for example, Al, Sc, Y, Zr, Hf, and lanthanoids. Lanthanoids are La, Ce, Pr, Nd, Pm, Sm, Eu, Gd, Tb, Dy, Ho, Er, Tm, Yb, and Lu. When the solid electrolyte contains the element E, a potential window of the solid electrolyte layer extends and an ion conductivity increases. E preferably includes Sc or Zr, and particularly preferably includes Zr. When E includes Sc or Zr, the ion conductivity of the solid electrolyte increases.

In the solid electrolyte represented by the above-described Formula (1), G is an element that is contained as needed. G is at least one element selected from the group consisting of Na, K, Rb, Cs, Mg, Ca, Sr, Ba, B, Si, Al, Ti, Cu, Sc, Y, Zr, Nb, Ag, In, Sn, Sb, Hf, Ta, W, Au, and Bi. When the solid electrolyte contains the G element, an amount of lithium ions serving as carrier ions increases or decreases to increase the ion conductivity, and the potential window on a reduction side extends.

G in Formula (1) may be a monovalent element selected from Na, K, Rb, Cs, and Ag among those described above. If G is a monovalent element, the solid electrolyte has high ion conductivity and a wide potential window on the reduction side. G is particularly preferably Na and/or Cs.

G in Formula (1) may be a divalent element selected from Mg, Ca, Ba, Sr, Cu, and Sn among those described above. If G is a divalent element, the number of carrier ions increases, resulting in the solid electrolyte with high ion conductivity and a wide potential window on the reduction side. G is particularly preferably Mg and/or Ca.

G in Formula (1) may be trivalent element selected from Al, Y, In, Au, and Bi among those described above. If G is a trivalent element, the number of carrier ions increases, resulting in the solid electrolyte with high ion conductivity. G is particularly preferably any one selected from the group consisting of In, Au, and Bi.

G in Formula (1) may be Zr, Hf, and Sn which are tetravalent elements among those described above. If G is a tetravalent element, the solid electrolyte has high ion conductivity. G particularly preferably includes Hf and/or Zr.

G in Formula (1) may be a pentavalent element selected from Nb, Sb, and Ta among those described above. If G is a pentavalent element, holes are formed to facilitate movement of carrier ions, resulting in the solid electrolyte with high ion conductivity. G particularly preferably includes Sb and/or Ta.

G in Formula (1) may be W which is a hexavalent element among those described above. If G is a hexavalent element, the solid electrolyte has high ion conductivity.

D in Formula (1) is contained as needed. D is at least one selected from the group consisting of CO₃, SO₄, BO₃, POs, NO₃, SiO₃, OH, and O₂. When the solid electrolyte contains D, the solid electrolyte has a wide potential window on the reduction side. D is preferably at least one selected from the group consisting of SO₄, CO₃, POs, and O₂, and particularly preferably SO₄. When a covalent character between D and E is strong, an ionic bond between E and X is also strong. Therefore, it is presumed that E in a compound is difficult to be reduced and the compound has a wide potential window on the reduction side.

X in Formula (1) is an essential element. X is at least one selected from the group consisting of F, Cl, Br, and I. X has a large ionic radius per valence. When the solid electrolyte contains X, conductivity of lithium ions in the solid electrolyte increases. In order to increase the ion conductivity of the solid electrolyte, X preferably includes Cl. In order to improve a balance between oxidation resistance and reduction resistance of the solid electrolyte, X preferably includes F. In order to increase reduction resistance of the solid electrolyte, X preferably includes I.

In Formula (1), a=nb when n=(valence of E)−(valence of G). When b=0 (when G is not incorporated) in Formula (1), a=0. In Formula (1), a is the above-described numerical value determined according to the valence of G.

In Formula (1), b is 0 or more and less than 0.5. The solid electrolyte represented by Formula (1) may not contain G while containing E as an essential element. If b is 0.1 or more, an effect obtained by incorporating G in the solid electrolyte can be sufficiently obtained. Also, when b is less than 0.5, it is possible to suppress a decrease in ion conductivity of the solid electrolyte due to a too high G content. b is preferably 0.45 or less.

In Formula (1), x is 0 or more and 5 or less. Therefore, D may not be contained in the solid electrolyte. When D is contained in the compound represented by Formula (1), c is preferably 0.1 or more. When c is 0.1 or more, an effect of extending the potential window on the reduction side of the solid electrolyte due to D being contained can be sufficiently obtained. If a D content is too high, there is a concern that the ion conductivity of the solid electrolyte will decrease due to a decrease in space in which carrier ions move, and therefore, from a viewpoint of suppressing that, c is 5 or less, and preferably 2.5 or less.

In Formula (1), d is larger than 0 and 7.1 or less. If d is 7.1 or less, this is preferable because a constraint force to carrier ions due to too high X content can be suppressed, and a decrease in ion conductivity of the solid electrolyte can be suppressed.

In Formula (1), e is 0 or more and 2 or less. Also, e is 0<d-e. When Formula (1) satisfies 0≤e≤2 and 0<d-e, an Li content and an X content contained in the compound represented by Formula (1) are appropriate, and the ion conductivity of the solid electrolyte increases.

In order to obtain a solid electrolyte with a wide potential window and a high ion conductivity, the solid electrolyte represented by Formula (1) preferably has Zr as E and Cl as X. Specifically, the compound represented by Formula (1) is preferably Li₂ZrCl₆, Li₂ZrSO₄Cl₄, or Li₂ZrOCl₄ as a solid electrolyte with a satisfactory balance between the ion conductivity and the potential window.

The solid electrolyte layer 15 may contain other substances in addition to the solid electrolyte represented by Formula (1). Other substances are at least one compound selected from the group consisting of, for example, Li₂O, LiX (X is at least one element selected from the group consisting of F, Cl, Br, and I.), Sc₂O₃, ScX₃ (X is at least one element selected from the group consisting of F, Cl, Br, and I.), and GOₙ (G is at least one element selected from the group consisting of Na, K, Rb, Cs, Mg, Ca, Sr, Ba, B, Si, Al, Ti, Cu, Y, Zr, Nb, Ag, In, Sn, Sb, Hf, Ta, W, Au, and Bi. n=m/2 when the valence of G is m.).

When the solid electrolyte layer 15 contains other substances described above, the ion conductivity of the solid electrolyte layer 15 increases. Although details of the reason are unknown, it can be considered as follows. In the solid electrolyte layer 15, the above-described other substances have a function of helping ionic connection between particles formed of the solid electrolyte represented by Formula (1). Thereby, it is presumed that grain-boundary resistance between the particles of the solid electrolyte represented by Formula (1) is reduced and the ion conductivity of the solid electrolyte layer 15 increases in its entirety.

An amount of other substances in the solid electrolyte layer 15 is, for example, 0.1% by mass or more and 1.0% by mass or less. When the amount of other substances is 0.1% by mass or more, the effect of reducing the grain-boundary resistance between particles becomes remarkable. Also, when the amount of other substances is 1.0% by mass or less, the solid electrolyte layer 15 becoming hard and making it difficult for the interface that helps ionic connection between the particles to be satisfactorily formed between the particles is avoided.

The solid electrolyte layer 15 may contain a binding material. The solid electrolyte layer 15 may contain, for example, a fluorine-based resin such as polyvinylidene fluoride (PVDF) and polytetrafluoroethylene (PTFE), cellulose, styrene-butadiene rubber, ethylene-propylene rubber, an imide-based resin such as a polyimide resin and a polyamide-imide resin, an ion conductive polymer, or the like. The ion conductive polymer includes, for example, a compound in which a monomer of a polymer compound (a polyether-based polymer compound such as a polyethylene oxide and a polypropylene oxide, polyphosphazene, or the like), and a lithium salt such as LiClO₄, LiBF₄, LiPF₆, and LiTFSI, or an alkali metal salt mainly composed of lithium are composited. A content rate of the binding material is preferably 0.1% by volume or more and 30% by volume or less of the entire solid electrolyte layer 15. The binding material helps maintain satisfactory bonding between the solid electrolytes of the solid electrolyte layer 15, prevents generation of cracks or the like between the solid electrolytes, and suppresses a decrease in ion conductivity and an increase in grain-boundary resistance.

### “Positive Electrode”

As illustrated in FIG. 2, the positive electrode 11 includes, for example, the positive electrode current collector 11A and the positive electrode active material layer 11B containing a positive electrode active material.

### (Positive Electrode Current Collector)

The positive electrode current collector 11A preferably has high conductivity. For example, a metal such as silver, palladium, gold, platinum, aluminum, copper, nickel, titanium, and stainless steel, and an alloy thereof, or a conductive resin can be used. The positive electrode current collector 11A may be in a form of powder, foil, punched, or expanded. From the perspective of not decreasing a current collecting function of the positive electrode current collector, the positive electrode current collector is preferably dehydrated by heating and drying in vacuum or the like in a glove box in which argon gas is circulated, and then stored using a glass bottle, an aluminum laminate bag, or the like. A dew point in the glove box is preferably set to be −30° C. or lower and −90° C. or higher.

### (Positive Electrode Active Material Layer)

Mixing of a positive electrode mixture used for the positive electrode active material layer 11B is preferably performed using, for example, an agate mortar, a pot mill, a blender, a hybrid mixer, or the like in a glove box in which argon gas is circulated. A dew point in the glove box is preferably set to be −30° C. or lower and −90° C. or higher from the perspective of performing satisfactory pressure molding. An oxygen concentration in the glove box is set to, for example, 1 ppm or less.

The positive electrode active material layer 1B is formed on one side or both sides of the positive electrode current collector 1A. The positive electrode active material layer 1B contains a positive electrode active material. The positive electrode active material layer 1B may contain, for example, the solid electrolyte represented by the above-described Formula (1). Also, the positive electrode active material layer 1B may also contain a conductive auxiliary agent and a binding material.

### (Positive Electrode Active Material)

The positive electrode active material contained in the positive electrode active material layer 11B includes, for example, lithium-containing transition metal oxides, transition metal fluorides, polyanions, transition metal sulfides, transition metal oxyfluorides, transition metal oxysulfides, and transition metal oxynitrides.

The positive electrode active material is not particularly limited as a positive electrode active material as long as release and absorption of lithium ions and desorption and insertion of lithium ions are allowed to progress in a reversible manner, and positive electrode active materials used in known lithium ion secondary batteries can be utilized. The positive electrode active material includes, for example, lithium cobalt oxide (LiCoO₂), lithium nickel oxide (LiNiO₂), lithium manganese spinel (LiMn₂O₄), composite metal oxides represented by a general formula: LiNiₓCo_{y}Mn_{z}MₐO₂ (x+y+z+a=1, 0≤x≤1, 0≤y≤1, 0≤z≤1, and 0≤a≤1, M is one or more elements selected from Al, Mg, Nb, Ti, Cu, Zn, and Cr), a lithium vanadium compound (LiV₂O₅, Li₃V₂(PO₄)₃, LiVOPO₄), olivine type LiMPO₄ (in which, M represents one or more elements selected from Co, Ni, Mn, Fe, Mg, V, Nb, Ti, Al, and Zr), lithium titanate (Li₄Ti₅O₁₂), and composite metal oxides such as LiNiₓCo_{y}Al_{z}O₂ (0.9<x+y+z<1.1). From the perspective of satisfactory pressure molding, the positive electrode active material used for the positive electrode active material layer 11B is preferably dehydrated by heating and drying in vacuum or the like in a glove box in which argon gas is circulated, and then stored using a glass bottle, an aluminum laminate bag, or the like. A dew point in the glove box is preferably set to be −30° C. or lower and −90° C. or higher.

Also, if a negative electrode active material doped with metallic lithium or lithium ions has been placed in the negative electrode in advance, a positive electrode active material that does not contain lithium can also be used by starting the battery from discharging. As such a positive electrode active material, lithium-free metal oxides (MnO₂, V₂O₅, and the like), lithium-free metal sulfides (MoS₂, and the like), lithium-free fluorides (FeF₃, VF₃, and the like), and the like can be mentioned.

### “Negative Electrode”

As illustrated in FIG. 2, the negative electrode 13 includes, for example, the negative electrode current collector 13A and the negative electrode active material layer 13B containing a negative electrode active material.

### (Negative Electrode Current Collector)

The negative electrode current collector 13A preferably has high conductivity. For example, it is preferable to use a metal such as silver, palladium, gold, platinum, aluminum, copper, nickel, stainless steel, and iron, and an alloy thereof, or a conductive resin. The negative electrode current collector 13A may be in a form of powder, foil, punched, or expanded. From the perspective of not decreasing a current collecting function of the negative electrode current collector, the negative electrode current collector is preferably dehydrated by heating and drying in vacuum or the like in a glove box in which argon gas is circulated, and then stored using a glass bottle, an aluminum laminate bag, or the like. A dew point in the glove box is preferably set to be −30° C. or lower and −90° C. or higher.

### (Negative Electrode Active Material Layer)

Mixing of a negative electrode mixture used for the negative electrode active material layer 13B is preferably performed using, for example, an agate mortar, a pot mill, a blender, a hybrid mixer, or the like in a glove box in which argon gas is circulated. A dew point in the glove box is preferably set to be −30° C. or lower and −90° C. or higher from the perspective of performing satisfactory pressure molding. An oxygen concentration in the glove box is set to, for example, 1 ppm or less.

The negative electrode active material layer 13B is formed on one side or both sides of the negative electrode current collector 13A. The negative electrode active material layer 13B contains a negative electrode active material. The negative electrode active material layer 13B may contain, for example, the solid electrolyte represented by the above-described Formula (1). Also, the negative electrode active material layer 13B may also contain a conductive auxiliary agent and a binding material.

### (Negative Electrode Active Material)

The negative electrode active material contained in the negative electrode active material layer 13B may be any compound capable of absorbing and releasing mobile ions, and negative electrode active materials used in known lithium ion secondary batteries can be used. The negative electrode active material includes, for example, alkali metal simple substances, alkali metal alloys, carbon materials such as graphite (natural graphite, artificial graphite), carbon nanotubes, non-graphitizable carbon, easily graphitizable carbon, and low-temperature calcined carbon, metals such as aluminum, silicon, tin, and germanium, and alloys thereof that can combine with metals such as alkali metals, oxides such as SiOₓ (0≤x<2), iron oxides, titanium oxides, tin dioxides, and lithium metal oxides such as lithium titanate (Li₄Ti₅O₁₂). From the perspective of satisfactory pressure molding, the negative electrode active material used for the negative electrode active material layer 13B is preferably dehydrated by heating and drying in vacuum or the like in a glove box in which argon gas is circulated, and then stored using a glass bottle, an aluminum laminate bag, or the like. A dew point in the glove box is preferably set to be −30° C. or lower and −90° C. or higher.

### (Conductive Auxiliary Agent)

The conductive auxiliary agent is not particularly limited as long as it improves electron conductivity of the positive electrode active material layer 11B and the negative electrode active material layer 13B, and known conductive auxiliary agents can be used. The conductive auxiliary agents include, for example, carbon-based materials such as graphite, carbon black, graphene, and carbon nanotubes, metals such as gold, platinum, silver, palladium, aluminum, copper, nickel, stainless steel, and iron, and conductive oxides such as ITO, or mixtures thereof. The conductive auxiliary agent may be in a form of powder or fiber. Also, from the perspective of not decreasing a current collecting function of the conductive auxiliary agent, the conductive auxiliary agent is preferably dehydrated by heating and drying in vacuum or the like in a glove box in which argon gas is circulated, and then stored using a glass bottle, an aluminum laminate bag, or the like. A dew point in the glove box is preferably set to be −30° C. or lower and −90° C. or higher.

### (Binding Material)

The binding material bonds the positive electrode current collector 11A and the positive electrode active material layer 11B together, the negative electrode current collector 13A and the negative electrode active material layer 13B together, the positive electrode active material layer 11B and the negative electrode active material layer 13B to the solid electrolyte layer 15, various materials forming the positive electrode active material layer 11B, and various materials forming the negative electrode active material layer 13B.

The binding material is preferably used within a range that does not impair the functions of the positive electrode active material layer 11B and the negative electrode active material layer 13B. Any binding material may be used as long as the above-described bonding is possible, and examples thereof include fluorine resins such as polyvinylidene fluoride (PVDF) and polytetrafluoroethylene (PTFE). Further, in addition to the above, as the binding material, for example, cellulose, styrene-butadiene rubber, ethylene-propylene rubber, a polyimide resin, a polyamide-imide resin, or the like may be used. Also, a conductive polymer having electron conductivity or an ion conductive polymer having ion conductivity may be used as the binding material. As the conductive polymer having electron conductivity, polyacetylene or the like can be mentioned. In this case, since the binding material also exhibits a function of conductive auxiliary particles, the conductive auxiliary agent may not be added. As the ion conductive polymer having ion conductivity, for example, one that conducts lithium ions can be used, and examples thereof include those in which a monomer of a polymer compound (a polyether-based polymer compound such as a polyethylene oxide and a polypropylene oxide, polyphosphazene, or the like), and a lithium salt such as LiClO₄, LiBF₄, LiPF₆, LiTFSI, and LIFSI, or an alkali metal salt mainly composed of lithium are composited. A polymerization initiator used for compositing includes, for example, a photopolymerization initiator, a thermal polymerization initiator, or the like suitable for the above-described monomer. Properties required for the binding material include oxidation/reduction resistance and satisfactory adhesiveness.

A binder content in the positive electrode active material layer 11B is not particularly limited, but is preferably 0.5 to 30% by volume of the positive electrode active material layer from the perspective of lowering resistance of the positive electrode active material layer 11B. The binder content is preferably 0% by volume from the perspective of improving an energy density thereof.

A binder content in the negative electrode active material layer 13B is not particularly limited, but is preferably 0.5 to 30% by volume of the negative electrode active material layer from the perspective of lowering resistance of the negative electrode active material layer 13B. The binder content is preferably 0% by volume from the perspective of improving an energy density thereof.

A non-aqueous electrolyte, an ionic liquid, or a gel electrolyte may be contained in at least one of the positive electrode active material layer 11B, the negative electrode active material layer 13B, and the solid electrolyte layer 15 for the purpose of improving rate characteristics which are one of battery characteristics.

### “Method for Producing Solid Electrolyte”

A method for producing the solid electrolyte represented by Formula (1) will be described. The solid electrolyte can be obtained by mixing and reacting raw material powders at a predetermined molar ratio to obtain an intended composition. A method for causing a reaction is not limited, but a mechanochemical milling method, a sintering method, a melting method, a liquid phase method, a solid phase method, and the like can be used.

The solid electrolyte can be produced, for example, by a mechanochemical milling method. First, a planetary ball mill device is prepared. The planetary ball mill is a device in which media (hard balls for pulverizing or promoting mechanochemical reactions) and materials are loaded into a dedicated container, and which rotates and revolves to pulverize the materials or cause mechanochemical reactions between the materials.

For the solid electrolyte, a predetermined amount of zirconia balls are prepared, for example, in a zirconia container in a glove box in which argon gas is circulated. From the perspective of stably synthesizing a target compound, a dew point in the glove box is preferably set to be −30° C. or lower and −90° C. or higher. An oxygen concentration in the glove box is, for example, 1 ppm or less.

Next, predetermined raw materials are prepared in a zirconia container at a predetermined molar ratio to obtain an intended composition, and the container is sealed with a zirconia lid. The raw material may be powders or a liquid. For example, titanium chloride (TiCl₄) and tin chloride (SnCl₄) are liquid at room temperature. Next, mechanochemical milling is performed for a predetermined time at predetermined speeds of rotation and revolution to cause a mechanochemical reaction. By this method, a solid electrolyte in a powder form composed of a compound having an intended composition can be obtained.

“Method for Producing all-Solid-State Battery”

Next, a method for producing an all-solid-state battery according to the present embodiment will be described. The all-solid-state battery according to the present embodiment can be manufactured, for example, by a method including an element manufacturing step of manufacturing the battery element 10, and a housing step of housing the battery element 10 in the exterior body 20. The battery element 10 according to the present embodiment is manufactured using, for example, a powder molding method. The powder molding method is performed in an environment with a dew point of lower than −20° C. and −90° C. or higher. The powder molding method is preferably performed in an environment with a dew point of −30° C. or lower and −85° C. or higher. The powder molding method is performed by, for example, adjusting a dew point in the glove box.

### (Element Preparation Step: Powder Molding Method)

First, a resin holder having a through hole at a center, a lower punch, and an upper punch are prepared. A metal holder made of dies steel may be used instead of the resin holder to improve moldability. A diameter of the through hole of the resin holder is, for example, 10 mm, and diameters of the lower punch and the upper punch are, for example, 9.99 mm. The lower punch is inserted from below the through hole of the resin holder, and a solid electrolyte in a powder form is loaded from an opening side of the resin holder. Next, the upper punch is inserted onto the loaded solid electrolyte in a powder form, and this is placed in a pressing machine to be pressed. A pressure of the pressing is, for example, 373 MPa. The solid electrolyte in a powder form is pressed by the upper punch and the lower punch in the resin holder, and thereby the solid electrolyte layer 15 is formed.

Next, the upper punch is temporarily removed, and a material of the positive electrode active material layer is loaded on the upper punch side of the solid electrolyte layer 15. Thereafter, the upper punch is inserted again and pressed. A pressure of the pressing is, for example, 373 MPa. The material of the positive electrode active material layer becomes the positive electrode active material layer 11B due to the pressing.

Next, the lower punch is temporarily removed, and a material of the negative electrode active material layer is loaded on the lower punch side of the solid electrolyte layer 15. For example, the sample is inverted upside down, and the material of the negative electrode active material layer is loaded onto the solid electrolyte layer 15 to face the positive electrode active material layer 11B. Thereafter, the lower punch is inserted again and pressed. A pressure of the pressing is, for example, 373 MPa. The material of the negative electrode active material layer becomes the negative electrode active material layer 13B due to the pressing.

Next, the upper punch is temporarily removed, and the positive electrode current collector 11A and the upper punch are inserted in that order onto the positive electrode active material layer 11B. Also, the lower punch is temporarily removed, and the negative electrode current collector 13A and the lower punch are inserted in that order onto the negative electrode active material layer 13B. The positive electrode current collector 11A and the negative electrode current collector 13A are, for example, an aluminum foil or a copper foil with a diameter of 10 mm. Through the above-described procedure, the battery element 10 of the present embodiment with the positive electrode current collector 11A/the positive electrode active material layer 11B/the solid electrolyte layer 15/the negative electrode active material layer 13B/the negative electrode current collector 13A is obtained.

As needed, using a stainless steel disc and a Bakelite disc having screw holes at four positions, the battery element 10 may be stacked in order of the stainless steel disc/the Bakelite disc/the upper punch/the battery element 10/the lower punch/the Bakelite disc/the stainless steel disc, and fastened by the screws at the four positions. This is preferable from the perspective of further improving the bonding between the upper punch and the positive electrode current collector 11A, between the positive electrode current collector 11A and the positive electrode active material 11B, between the lower punch and the negative electrode current collector 13A, and between the negative electrode current collector 13A and the negative electrode active material 13B. The battery element 10 may be a similar mechanism having a shape-retaining function.

### Housing Step

The housing step is performed, for example, in a glove box in which argon gas is circulated. A dew point in the glove box is lower than −20° C. and −90° C. or higher. The dew point in the glove box is preferably −30° C. or lower and −85° C. or higher. An oxygen concentration in the glove box is, for example, 1 ppm or less.

The screws are inserted into screw holes provided on side surfaces of the upper punch and the lower punch to be inserted into the exterior body to which the external terminals 12 and 14 are attached, and the screws attached to the side surfaces of the upper punch and the lower punch are connected to the external terminals 12 and 14 with lead wires or the like. Thereafter, it is housed in the exterior body 20, and an opening of the exterior body 20 is sealed by heat sealing. Weather resistance of the all-solid-state battery 100 is improved by the exterior body 20.

Although the method for producing the battery element 10 described above has been described by taking the powder molding method as an example, the battery element 10 may also be produced by a sheet molding method with a sheet containing a resin. The sheet molding method is also manufactured in the glove box. The sheet molding method is also performed in an environment with a dew point of lower than −20° C. and −90° C. or higher. The sheet molding method is preferably performed in an environment with a dew point of −30° C. or lower and −85° C. or higher. The sheet molding method is performed by, for example, adjusting the dew point in the glove box.

For example, first, a solid electrolyte paste containing a solid electrolyte in a powder form is prepared. The solid electrolyte layer 15 is manufactured by applying the prepared solid electrolyte paste onto a PET film, a fluorine-based resin film, or the like, drying it, temporally molding it, and peeling it. Also, the positive electrode 11 is manufactured by applying a positive electrode active material paste containing a positive electrode active material onto the positive electrode current collector 11A, drying it, and temporally molding it to form the positive electrode active material layer 11B. Also, the negative electrode 13 is manufactured by applying a paste containing a negative electrode active material onto the negative electrode current collector 13A, drying it, and temporarily molding it to form the negative electrode active material layer 13B. The positive electrode 11, the negative electrode 13, and the solid electrolyte layer 15 can be punched into a required size and shape.

Next, the solid electrolyte layer 15 is sandwiched between the positive electrode 11 and the negative electrode 13 so that the positive electrode active material layer 11B and the negative electrode active material layer 13B face the solid electrolyte layer 15, and these are pressed and bonded in their entirety. Through the steps described above, the battery element 10 of the present embodiment can be obtained.

The all-solid-state battery 100 according to the present embodiment is manufactured under an environment in which a moisture content is adjusted, and when the moisture content in the housing space K is made less than 1100 ppmv, the charge/discharge efficiency of the all-solid-state battery 100 improves because deterioration of the current collecting function due to corrosion of metal portions (a current collector, a conductive auxiliary agent, a storage container, and the like) of the battery element 10 caused by halogenated gas can be suppressed, and a locally uneven electrochemical reaction can be suppressed.

Although embodiments of the present invention have been described in detail with reference to the drawings, configurations, combinations thereof, or the like in the respective embodiments are examples, and additions, omissions, substitutions, and other changes to the configurations can be made within a scope not departing from the gist of the present invention.

### EXAMPLE

### Example 1

### Synthesis of Solid Electrolyte

A solid electrolyte was synthesized in a glove box with a dew point of −85° C. and an oxygen concentration of 1 ppm in which argon gas was circulating. First, as raw material powders, Li₂SO₄ and ZrCl₄ were weighed so that a molar ratio was 1:1. Next, the weighed raw material powders were put in a Zr container together with Zr balls with a diameter of 5 mm, and mechanochemical milling processing was performed using a planetary ball mill. The processing was performed by mixing them for 50 hours under the condition of a rotation speed of 500 rpm and then sieving them through a 200 μm mesh. Thereby, powders of Li₂ZrSO₄Cl₄ were obtained as a solid electrolyte.

### Mixing of Positive Electrode Mixture-

Next, a positive electrode mixture was weighed and mixed in a glove box with a dew point of −85° C. and an oxygen concentration of 1 ppm in which argon gas was circulating. Weighing was performed so that lithium cobalt oxide (LiCoO₂):Li₂ZrSO₄Cl₄:carbon black=77:18:5 parts by weight, and mixing was performed for 5 minutes in an agate mortar to obtain a positive electrode mixture.

### Mixing of Negative Electrode Mixture-

Next, a negative electrode mixture was weighed and mixed in a glove box with a dew point of −85° C. and an oxygen concentration of 1 ppm in which argon gas was circulating. Weighing was performed so that lithium titanate (Li₄Ti₅O₁₂):Li₂ZrSO₄Cl₄:carbon black=72:22:6 parts by weight, and mixing was performed for 5 minutes in an agate mortar to obtain a negative electrode mixture.

### Molding Step

Using the solid electrolyte, the positive electrode mixture, and the negative electrode mixture described above, a battery element formed of a positive electrode current collector/a positive electrode mixture layer/an electrolyte layer/a negative electrode mixture layer/a negative electrode current collector was manufactured by the powder molding method. Manufacture of the battery element was performed in a glove box with a dew point of −85° C. and an oxygen concentration of 1 ppm in which argon gas was circulated.

First, a resin holder having a through hole at a center, a lower punch made of SKD11 material, and an upper punch were prepared.

The lower punch was inserted from below the through hole of the resin holder, and 110 mg of the solid electrolyte was loaded from an opening side of the resin holder. The upper punch was then inserted onto the solid electrolyte. This first unit was placed in a pressing machine and pressed at a pressure of 373 MPa to form a solid electrolyte layer. The first unit was taken out from the pressing machine and the upper punch was removed.

Next, 12 mg of the positive electrode mixture was loaded onto the solid electrolyte layer (on the upper punch side) from the opening side of the resin holder, the upper punch was inserted thereon, and this second unit was left to stand in the pressing machine and formed at a pressure of 373 MPa. Next, the second unit was taken out and inverted upside down to remove the lower punch.

Next, 10 mg of the negative electrode mixture was loaded onto the solid electrolyte layer (on the lower punch side), and this third unit was left to stand in the pressing machine and formed at a pressure of 373 MPa.

Next, the upper punch was temporarily removed, and the positive electrode current collector (aluminum foil, diameter of 10 mm, thickness of 20 um) and the upper punch were inserted onto the positive electrode active material layer in that order. Also, the lower punch was temporarily removed, and the negative electrode current collector (copper foil, diameter of 10 mm, thickness of 10 um) and the lower punch were inserted onto the negative electrode active material layer in that order. In this way, a battery element formed of the positive electrode current collector/the positive electrode active material layer/the solid electrolyte layer/the negative electrode active material layer/the negative electrode current collector was manufactured.

Housing Step Next, the obtained battery element was housed in an exterior body. The battery element was housed in a glove box having a dew point of −85° C. and an oxygen concentration of 1 ppm in which argon gas was circulating.

First, a stainless steel disc and a Bakelite disc with a diameter of 50 mm and a thickness of 5 mm having screw holes at four positions were prepared, and the battery element was set as follows. The stainless steel disc/the Bakelite disc/the upper punch/the battery element/the lower punch/the Bakelite disc/the stainless steel disc were stacked in that order, and the screws at the four positions were fastened to manufacture a fourth unit. Further, screws for connecting external terminals were inserted into the screw holes on side surfaces of the upper punch and the lower punch.

An aluminum laminate bag of A4 size was prepared as an exterior body to seal the fourth unit. As external terminals, an aluminum foil (a width of 4 mm, a length of 40 mm, and a thickness of 100 μm) wrapped with maleic anhydride-grafted polypropylene (PP) and a nickel foil (a width of 4 mm, a length of 40 mm, and a thickness of 100 μm) were thermally bonded to one side of an opening of the aluminum laminate bag with a space therebetween not to cause a short circuit. The fourth unit was inserted into the aluminum laminate bag to which the external terminals were attached, and the screw on the side surface of the upper punch and the aluminum terminal extending into the inside of the exterior body, and the screw on the side surface of the lower punch and the nickel terminal extending into the inside of the exterior body are connected with lead wires. Finally, the opening was heat-sealed to manufacture an all-solid-state battery.

After a charge/discharge test was performed, the positive electrode current collector and the negative electrode current collector were taken out, surfaces thereof were observed using an optical microscope (50× objective lens), and an area of a portion thereof having a different contrast from an unused positive electrode current collector or negative electrode current collector was obtained.

A moisture content in the housing space K was measured in the glove box with a dew point of −90° C., an oxygen concentration of 1 ppm, and a temperature of 25° C. in which argon gas was circulating using a capacitive transmitter (Easidew Online, +ED Transmitter-99J, manufactured by Michell Instruments).

The charge/discharge test was performed in a constant-temperature bath at 25° C. Charging was performed at a constant current and constant voltage up to 2.8 V at 0.05 C. Charging ended when the current reached 1/40 C. Discharging was performed at a constant current of 0.05 C down to 1.3 V. Then, an initial charge/discharge efficiency was calculated from the following Formula (2).

Initial charge/discharge efficiency[%]=(First cycle discharge capacity [Ah]/First cycle charge capacity[Ah])×100 (1)

Results of example 1 were summarized in Table 1 to be described later.

### Examples 2 to 8 and Comparative Examples 1 and 2

In examples 2 to 8 and comparative examples 1 and 2, observation of change in color of the positive electrode current collector and the negative electrode current collector, a moisture content in the housing space K, and an initial charge/discharge efficiency of the all-solid-state battery were measured in the same manner as in example 1 except that the battery element was housed in a glove box with a dew point of −20 to −85° C. and an oxygen concentration of 1 ppm in which argon gas was circulating. Results of examples 2 to 8 and comparative examples 1 and 2 were summarized in Table 1 below.

### Example 9

In Example 9, a solid electrolyte was synthesized in a glove box with a dew point of −85° C. and an oxygen concentration of 1 ppm in which argon gas was circulating. First, as raw material powders, LiCI and ZrCl₄ were weighed so that a molar ratio was 2:1. Next, the weighed raw material powders were put in a Zr container together with Zr balls with a diameter of 5 mm, and mechanochemical milling processing was performed using a planetary ball mill. The processing was performed by mixing them for 50 hours under the condition of a rotation speed of 500 rpm and then sieving them through a 200 μm mesh. Thereby, Li₂ZrCl₆ was obtained as a solid electrolyte.

Example 9 differs from example 1 in that a composition of the solid electrolyte was changed. With other conditions the same as those in example 1, observation of change in color of the positive electrode current collector and the negative electrode current collector, a moisture content in the housing space K, and an initial charge/discharge efficiency of the all-solid-state battery were measured. Results of example 9 were summarized in Table 1 below.

### Examples 10 to 16 and Comparative Examples 3 and 4

In examples 10 to 16 and comparative examples 3 and 4, observation of change in color of the positive electrode current collector and the negative electrode current collector, a moisture content in the housing space K, and an initial charge/discharge efficiency of the all-solid-state battery were measured in the same manner as in example 9 except that the battery element was housed in a glove box with a dew point of -−20 to −85° C. and an oxygen concentration of 1 ppm in which argon gas was circulating. Results of examples 10 to 16 and comparative examples 3 and 4 were summarized in Table 1 below.

In example 17, a solid electrolyte was synthesized in a glove box with a dew point of −85° C. and an oxygen concentration of 1 ppm in which argon gas was circulating. First, as raw material powders, Li₂O and ZrCl₄ were weighed so that a molar ratio was 1:1. Next, the weighed raw material powders were put in a Zr container together with Zr balls with a diameter of 5 mm, and mechanochemical milling processing was performed using a planetary ball mill. The processing was performed by mixing them for 50 hours under the condition of a rotation speed of 500 rpm and then sieving them through a 200 μm mesh. Thereby, Li₂ZrOCl₄ was obtained as a solid electrolyte.

Example 17 differs from example 1 in that a composition of the solid electrolyte was changed. With other conditions the same as those in example 1, observation of change in color of the positive electrode current collector and the negative electrode current collector, a moisture content in the housing space K, and an initial charge/discharge efficiency of the all-solid-state battery were measured. Results of example 17 were summarized in Table 2 below.

### Examples 18 to 24 and Comparative Examples 5 and 6

In examples 18 to 24 and comparative examples 5 and 6, observation of change in color of the positive electrode current collector and the negative electrode current collector, a moisture content in the housing space K, and an initial charge/discharge efficiency of the all-solid-state battery were measured in the same manner as in example 17 except that the battery element was housed in a glove box with a dew point of −20 to −85° C. and an oxygen concentration of 1 ppm in which argon gas was circulating. Results of examples 18 to 24 and comparative examples 5 and 6 were summarized in Table 2 below.

In example 25, a solid electrolyte was synthesized in a glove box with a dew point of −85° C. and an oxygen concentration of 1 ppm in which argon gas was circulating. As raw material powders, Li₂SO₄ and ZrCl₄ were weighed so that a molar ratio was 0.9:1. Next, the weighed raw material powders were put in a Zr container together with Zr balls with a diameter of 5 mm, and mechanochemical milling processing was performed using a planetary ball mill. The processing was performed by mixing them for 50 hours under the condition of a rotation speed of 500 rpm and then sieving them through a 200 μm mesh. Thereby, Li_{1.8}Zr(SO₄)_{0.9}Cl₄ was obtained as a solid electrolyte.

Example 25 differs from example 1 in that a composition of the solid electrolyte was changed. With other conditions the same as those in example 1, observation of change in color of the positive electrode current collector and the negative electrode current collector, a moisture content in the housing space K, and an initial charge/discharge efficiency of the all-solid-state battery were measured. Results of example 25 were summarized in Table 2 below.

### Examples 26 to 32 and Comparative Examples 7 and 8

In examples 26 to 32 and comparative examples 7 and 8, observation of change in color of the positive electrode current collector and the negative electrode current collector, a moisture content in the housing space K, and an initial charge/discharge efficiency of the all-solid-state battery were measured in the same manner as in example 25 except that the battery element was housed in a glove box with a dew point of −20 to −85° C. and an oxygen concentration of 1 ppm in which argon gas was circulating. Results of examples 26 to 32 and comparative examples 7 to 8 were summarized in Table 2 below.

In example 33, a solid electrolyte was synthesized in a glove box with a dew point of −85° C. and an oxygen concentration of 1 ppm in which argon gas was circulating. As raw material powders, Li₂SO₄ and ZrCl₄ were weighed so that a molar ratio was 1.1:1. Next, the weighed raw material powders were put in a Zr container together with Zr balls with a diameter of 5 mm, and mechanochemical milling processing was performed using a planetary ball mill. The processing was performed by mixing them for 50 hours under the condition of a rotation speed of 500 rpm and then sieving them through a 200 μm mesh. Thereby, Li_{2.2}Zᵣ(SO₄)_{1.1}Cl₄ was obtained as a solid electrolyte.

Example 33 differs from example 1 in that a composition of the solid electrolyte was changed. With other conditions the same as those in example 1, observation of change in color of the positive electrode current collector and the negative electrode current collector, a moisture content in the housing space K, and an initial charge/discharge efficiency of the all-solid-state battery were measured. Results of example 33 were summarized in Table 3 below.

### Examples 34 to 40 and Comparative Examples 9 and 10

In examples 34 to 40 and comparative examples 9 and 10, observation of change in color of the positive electrode current collector and the negative electrode current collector, a moisture content in the housing space K, and an initial charge/discharge efficiency of the all-solid-state battery were measured in the same manner as in example 33 except that the battery element was housed in a glove box with a dew point of −20 to −85° C. and an oxygen concentration of 1 ppm in which argon gas was circulating. Results of examples 34 to 40 and comparative examples 9 and 10 were summarized in Table 3 below.

In example 41, a solid electrolyte was synthesized in a glove box with a dew point of −85° C. and an oxygen concentration of 1 ppm in which argon gas was circulating. As raw material powders, Li₂SO₄ and ZrCl₄ were weighed so that a molar ratio was 1.5:1. Next, the weighed raw material powders were put in a Zr container together with Zr balls with a diameter of 5 mm, and mechanochemical milling processing was performed using a planetary ball mill. The processing was performed by mixing them for 50 hours under the condition of a rotation speed of 500 rpm and then sieving them through a 200 μm mesh. Thereby, Li₃Zr(SO₄)_{1.5}Cl₄ was obtained as a solid electrolyte.

Example 41 differs from example 1 in that a composition of the solid electrolyte was changed. With other conditions the same as those in example 1, observation of change in color of the positive electrode current collector and the negative electrode current collector, a moisture content in the housing space K, and an initial charge/discharge efficiency of the all-solid-state battery were measured. Results of example 41 were summarized in Table 3 below.

### Examples 42 to 48 and Comparative Examples 11 to 12

In examples 42 to 48 and comparative examples 11 and 12, observation of change in color of the positive electrode current collector and the negative electrode current collector, a moisture content in the housing space K, and an initial charge/discharge efficiency of the all-solid-state battery were measured in the same manner as in example 41 except that the battery element was housed in a glove box with a dew point of −20 to −85° C. and an oxygen concentration of 1 ppm in which argon gas was circulating. Results of examples 42 to 48 and comparative examples 11 and 12 were summarized in Table 3 below.

In example 49, a solid electrolyte was synthesized in a glove box with a dew point of −85° C. and an oxygen concentration of 1 ppm in which argon gas was circulating. As raw material powders, Li₃SO₄ and ZrCl₄ were weighed so that a molar ratio was 0.33:1. Next, the weighed raw material powders were put in a Zr container together with Zr balls with a diameter of 5 mm, and mechanochemical milling processing was performed using a planetary ball mill. The processing was performed by mixing them for 50 hours under the condition of a rotation speed of 500 rpm and then sieving them through a 200 μm mesh. Thereby, LiZr(PO₄)_{0.33}Cl₄ was obtained as a solid electrolyte.

Example 49 differs from example 1 in that a composition of the solid electrolyte was changed. With other conditions the same as those in example 1, observation of change in color of the positive electrode current collector and the negative electrode current collector, a moisture content in the housing space K, and an initial charge/discharge efficiency of the all-solid-state battery were measured. Results of example 49 were summarized in Table 4 below.

### Examples 50 to 56 and Comparative Examples 13 and 14

In examples 50 to 56 and comparative examples 13 and 14, observation of change in color of the positive electrode current collector and the negative electrode current collector, a moisture content in the housing space K, and an initial charge/discharge efficiency of the all-solid-state battery were measured in the same manner as in example 49 except that the battery element was housed in a glove box with a dew point of −20 to −85° C. and an oxygen concentration of 1 ppm in which argon gas was circulating. Results of examples 50 to 56 and comparative examples 13 and 14 were summarized in Table 4 below.

In example 57, a solid electrolyte was synthesized in a glove box with a dew point of −85° C. and an oxygen concentration of 1 ppm in which argon gas was circulating. As raw material powders, Li₃PO₄ and YCl₃ were weighed so that a molar ratio was 0.33:1. Next, the weighed raw material powders were put in a Zr container together with Zr balls with a diameter of 5 mm, and mechanochemical milling processing was performed using a planetary ball mill. The processing was performed by mixing them for 50 hours under the condition of a rotation speed of 500 rpm and then sieving them through a 200 μm mesh. Thereby, LiY(PO₄)_{0.33}Cl₃ was obtained as a solid electrolyte.

Example 57 differs from example 1 in that a composition of the solid electrolyte was changed. With other conditions the same as those in example 1, observation of change in color of the positive electrode current collector and the negative electrode current collector, a moisture content in the housing space K, and an initial charge/discharge efficiency of the all-solid-state battery were measured. Results of example 57 were summarized in Table 4 below.

### Examples 58 to 64, Comparative Examples 15 and 16

In examples 58 to 64 and comparative examples 15 and 16, observation of change in color of the positive electrode current collector and the negative electrode current collector, a moisture content in the housing space K, and an initial charge/discharge efficiency of the all-solid-state battery were measured in the same manner as in example 49 except that the battery element was housed in a glove box with a dew point of −20 to −85° C. and an oxygen concentration of 1 ppm in which argon gas was circulating. Results of examples 58 to 64 and comparative examples 15 and 16 were summarized in Table 4 below.

TABLE 1

| | | Dew | Moisture | | |
|---|---|---|---|---|---|
| | | point | content in | Area of | Charge/ |
| | | when | housing | change | discharge |
| | Solid | housed | space K | in color | efficiency |
| | electrolyte | (° C.) | (ppmv) | (mm²) | (%) |
| Example 1 | Li₂Zr(SO₄)Cl₄ | −85 | 0.26 | 0.24 | 95 |
| Example 2 | Li₂Zr(SO₄)Cl₄ | −80 | 0.55 | 0.39 | 95 |
| Example 3 | Li₂Zr(SO₄)Cl₄ | −70 | 2.77 | 0.55 | 93 |
| Example 4 | Li₂Zr(SO₄)Cl₄ | −60 | 10.5 | 0.63 | 92 |
| Example 5 | Li₂Zr(SO₄)Cl₄ | −50 | 41 | 0.94 | 90 |
| Example 6 | Li₂Zr(SO₄)Cl₄ | −40 | 135 | 1.18 | 90 |
| Example 7 | Li₂Zr(SO₄)Cl₄ | −30 | 415 | 2.43 | 85 |
| Example 8 | Li₂Zr(SO₄)Cl₄ | −25 | 650 | 4.24 | 79 |
| Comparative | Li₂Zr(SO₄)Cl₄ | −20 | 1120 | 19.2 | 55 |
| example 1 | | | | | |
| Comparative | Li₂Zr(SO₄)Cl₄ | −15 | 1680 | 29.8 | 49 |
| example 2 | | | | | |
| Example 9 | Li₂ZrCl₆ | −85 | 0.26 | 0.20 | 95 |
| Example 10 | Li₂ZrCl₆ | −80 | 0.56 | 0.35 | 94 |
| Example 11 | Li₂ZrCl₆ | −70 | 2.89 | 0.63 | 92 |
| Example 12 | Li₂ZrCl₆ | −60 | 10.9 | 0.71 | 92 |
| Example 13 | Li₂ZrCl₆ | −50 | 40.2 | 1.02 | 90 |
| Example 14 | Li₂ZrCl₆ | −40 | 135 | 1.34 | 88 |
| Example 15 | Li₂ZrCl₆ | −30 | 422 | 2.43 | 84 |
| Example 16 | Li₂ZrCl₆ | −25 | 645 | 5.65 | 77 |
| Comparative | Li₂ZrCl₆ | −20 | 1150 | 19.9 | 55 |
| example 3 | | | | | |
| Comparative | Li₂ZrCl₆ | −15 | 1650 | 31.6 | 50 |
| example 4 | | | | | |

TABLE 2

| | | | | | Charge/ |
|---|---|---|---|---|---|
| | | Dew | Moisture | | dis- |
| | | point | content in | Area of | charge |
| | | when | housing | change | effi- |
| | Solid | housed | space K | in color | ciency |
| | electrolyte | (° C.) | (ppmv) | (mm²) | (%) |
| Example 17 | Li₂ZrOCl₄ | −85 | 0.26 | 0.22 | 96 |
| Example 18 | Li₂ZrOCl₄ | −80 | 0.56 | 0.38 | 95 |
| Example 19 | Li₂ZrOCl₄ | −70 | 2.8 | 0.54 | 94 |
| Example 20 | Li₂ZrOCl₄ | −60 | 10.3 | 0.64 | 93 |
| Example 21 | Li₂ZrOCI₄ | −50 | 40 | 0.94 | 91 |
| Example 22 | Li₂ZrOCl₄ | −40 | 135 | 1.18 | 91 |
| Example 23 | Li₂ZrOCl₄ | −30 | 410 | 2.44 | 88 |
| Example 24 | Li₂ZrOCl₄ | −25 | 660 | 4.24 | 79 |
| Comparative | Li₂ZrOCl₄ | −20 | 1120 | 19.0 | 59 |
| example 5 | | | | | |
| Comparative | Li₂ZrOCl₄ | −15 | 1650 | 30.0 | 50 |
| example 6 | | | | | |
| Example 25 | Li_{1.8}Zr(SO₄)_{0.9}Cl₄ | −85 | 0.26 | 0.24 | 95 |
| Example 26 | Li_{1.8}Zr(SO₄)_{0.9}Cl₄ | −80 | 0.56 | 0.37 | 95 |
| Example 27 | Li_{1.8}Zr(SO₄)_{0.9}Cl₄ | −70 | 2.8 | 0.56 | 92 |
| Example 28 | Li_{1.8}Zr(SO₄)_{0.9}Cl₄ | −60 | 10.6 | 0.67 | 92 |
| Example 29 | Li_{1.8}Zr(SO₄)_{0.9}Cl₄ | −50 | 42 | 0.94 | 91 |
| Example 30 | Li_{1.8}Zr(SO₄)_{0.9}Cl₄ | −40 | 136 | 1.18 | 90 |
| Example 31 | Li_{1.8}Zr(SO₄)_{0.9}Cl₄ | −30 | 420 | 2.42 | 89 |
| Example 32 | Li_{1.8}Zr(SO₄)_{0.9}Cl₄ | −25 | 670 | 4.24 | 78 |
| Comparative | Li_{1.8}Zr(SO₄)_{0.9}Cl₄ | −20 | 1120 | 19.2 | 57 |
| example 7 | | | | | |
| Comparative | Li_{1.8}Zr(SO₄)_{0.9}Cl₄ | −15 | 1670 | 30.5 | 48 |
| example 8 | | | | | |

TABLE 3

| | | | | | Charge/ |
|---|---|---|---|---|---|
| | | Dew | Moisture | | dis- |
| | | point | content in | Area of | charge |
| | | when | housing | change | effi- |
| | Solid | housed | space K | in color | ciency |
| | electrolyte | (° C.) | (ppmv) | (mm²) | (%) |
| Example 33 | Li_{2.2}Zr(SO₄)_{1.1}Cl₄ | −85 | 0.26 | 0.24 | 94 |
| Example 34 | Li_{2.2}Zr(SO₄)_{1.1}Cl₄ | −80 | 0.56 | 0.37 | 94 |
| Example 35 | Li_{2.2}Zr(SO₄)_{1.1}Cl₄ | −70 | 2.8 | 0.56 | 93 |
| Example 36 | Li_{2.2}Zr(SO₄)_{1.1}Cl₄ | −60 | 10.4 | 0.67 | 92 |
| Example 37 | Li_{2.2}Zr(SO₄)_{1.1}Cl₄ | −50 | 40 | 0.94 | 90 |
| Example 38 | Li_{2.2}Zr(SO₄)_{1.1}Cl₄ | −40 | 134 | 1.18 | 90 |
| Example 39 | Li_{2.2}Zr(SO₄)_{1.1}Cl₄ | −30 | 420 | 2.42 | 87 |
| Example 40 | Li_{2.2}Zr(SO₄)_{1.1}Cl₄ | −25 | 680 | 4.24 | 77 |
| Comparative | Li_{2.2}Zr(SO₄)_{1.1}Cl₄ | −20 | 1120 | 19.2 | 57 |
| example 9 | | | | | |
| Comparative | Li_{2.2}Zr(SO₄)_{1.1}Cl₄ | −15 | 1680 | 30.5 | 49 |
| example 10 | | | | | |
| Example 41 | Li₃Zr(SO₄)_{1.5}Cl₄ | −85 | 0.26 | 0.24 | 89 |
| Example 42 | Li₃Zr(SO₄)_{1.5}Cl₄ | −80 | 0.56 | 0.37 | 88 |
| Example 43 | Li₃Zr(SO₄)_{1.5}Cl₄ | −70 | 2.8 | 0.56 | 88 |
| Example 44 | Li₃Zr(SO₄)_{1.5}Cl₄ | −60 | 10.6 | 0.67 | 86 |
| Example 45 | Li₃Zr(SO₄)_{1.5}Cl₄ | −50 | 42 | 0.94 | 85 |
| Example 46 | Li₃Zr(SO₄)_{1.5}Cl₄ | −40 | 136 | 1.18 | 83 |
| Example 47 | Li₃Zr(SO₄)_{1.5}Cl₄ | −30 | 410 | 2.42 | 81 |
| Example 48 | Li₃Zr(SO₄)_{1.5}Cl₄ | −25 | 670 | 4.24 | 73 |
| Comparative | Li₃Zr(SO₄)_{1.5}Cl₄ | −20 | 1110 | 19.2 | 50 |
| example 11 | | | | | |
| Comparative | Li₃Zr(SO₄)_{1.5}Cl₄ | −15 | 1660 | 30.5 | 45 |
| example 12 | | | | | |

TABLE 4

| | | | | | Charge/ |
|---|---|---|---|---|---|
| | | Dew | Moisture | | dis- |
| | | point | content in | Area of | charge |
| | | when | housing | change | effi- |
| | Solid | housed | space K | in color | ciency |
| | electrolyte | (° C.) | (ppmv) | (mm²) | (%) |
| Example 49 | LiZr(PO₄)_{0.33}Cl₄ | −85 | 0.26 | 0.26 | 94 |
| Example 50 | LiZr(PO₄)_{0.33}Cl₄ | −80 | 0.55 | 0.38 | 94 |
| Example 51 | LiZr(PO₄)_{0.33}Cl₄ | −70 | 2.8 | 0.56 | 92 |
| Example 52 | LiZr(PO₄)_{0.33}Cl₄ | −60 | 10.6 | 0.64 | 91 |
| Example 53 | LiZr(PO₄)_{0.33}Cl₄ | −50 | 40 | 0.94 | 89 |
| Example 54 | LiZr(PO₄)_{0.33}Cl₄ | −40 | 135 | 1.18 | 89 |
| Example 55 | LiZr(PO₄)_{0.33}Cl₄ | −30 | 415 | 2.43 | 84 |
| Example 56 | LiZr(PO₄)_{0.33}Cl₄ | −25 | 660 | 4.24 | 77 |
| Comparative | LiZr(PO₄)_{0.33}Cl₄ | −20 | 1120 | 19.2 | 55 |
| example 13 | | | | | |
| Comparative | LiZr(PO₄)_{0.33}Cl₄ | −15 | 1680 | 29.8 | 49 |
| example 14 | | | | | |
| Example 57 | LiY(PO₄)_{0.33}Cl₃ | −85 | 0.26 | 0.25 | 94 |
| Example 58 | LiY(PO₄)_{0.33}Cl₃ | −80 | 0.55 | 0.38 | 94 |
| Example 59 | LiY(PO₄)_{0.33}Cl₃ | −70 | 2.8 | 0.56 | 93 |
| Example 60 | LiY(PO₄)_{0.33}Cl₃ | −60 | 10.6 | 0.63 | 92 |
| Example 61 | LiY(PO₄)_{0.33}Cl₃ | −50 | 42 | 0.94 | 91 |
| Example 62 | LiY(PO₄)_{0.33}Cl₃ | −40 | 136 | 1.16 | 89 |
| Example 63 | LiY(PO₄)_{0.33}Cl₃ | −30 | 420 | 2.43 | 83 |
| Example 64 | LiY(PO₄)_{0.33}Cl₃ | −25 | 670 | 4.24 | 75 |
| Comparative | LiY(PO₄)_{0.33}Cl₃ | −20 | 1120 | 19.3 | 55 |
| example 15 | | | | | |
| Comparative | LiY(PO₄)_{0.33}Cl₃ | −15 | 1670 | 29.9 | 48 |
| example 16 | | | | | |

Since the moisture content in the housing space K was less than 1100 ppmv, and the change in color of the positive electrode current collector and the negative electrode current collector was suppressed, the all-solid-state batteries according to examples 1 to 64 all had better charge/discharge efficiencies than the all-solid-state batteries according to comparative examples 1 to 16.

Since the moisture content in the housing space K exceeded 1100 ppmv, and the change in color of the positive electrode current collector and the negative electrode current collector could not be suppressed, the all-solid-state batteries according to comparative examples 1 to 16 all had poor charge/discharge efficiencies.

### INDUSTRIAL APPLICABILITY

A battery with an excellent charge/discharge efficiency can be provided.

### REFERENCE SIGNS LIST

11 Positive electrode
11A Positive electrode current collector
11B Positive electrode active material layer
12 External terminal
13 Negative electrode
13A Negative electrode current collector
13B Negative electrode active material layer
14 External terminal
15 Solid electrolyte layer
10 Battery element
20 Exterior body
K Housing space
100 All-solid-state battery

1. A battery comprising a battery element including a positive electrode, a negative electrode, and a solid electrolyte layer between the positive electrode and the negative electrode, wherein
at least one of the positive electrode, the negative electrode, and the solid electrolyte layer includes a solid electrolyte represented by the following Formula (1),
Li₃₊ₐ₋ₑE_{1-b}G_{b}D_{c}X_{d-e} (1)
where, in Formula (1),
E is at least one element selected from the group consisting of Al, Sc, Y, Zr, Hf, and lanthanoids,
G is at least one element selected from the group consisting of Na, K, Rb, Cs, Mg, Ca, Sr, Ba, B, Si, Al, Ti, Cu, Sc, Y, Zr, Nb, Ag, In, Sn, Sb, Hf, Ta, W, Au, and Bi,
D is at least one selected from the group consisting of CO₃, SO₄, BO₃, PO₄, NO₃, SiO₃, OH, and O₂,
X is at least one element selected from the group consisting of F, Cl, Br, and I, and
when n=(valence of E)−(valence of G), a=nb, 0≤b<0.5, 0≤c≤5, 0≤d≤7.1, 0≤e≤2, and 0<d-e are satisfied,
the battery further comprising an exterior body covering the battery element, wherein
a moisture content in a housing space between the battery element and the exterior body is less than 1100 ppmv.

2. The battery according to claim 1, wherein a moisture content in the housing space is 600 ppmv or less.

3. A method for producing a battery comprising:
an element manufacturing step of sandwiching a solid electrolyte layer between a positive electrode and a negative electrode and pressure-forming thereof to manufacture a battery element; and
a housing step of housing the battery element in an exterior body, wherein
at least one of the positive electrode, the negative electrode, and the solid electrolyte layer includes a solid electrolyte represented by the following Formula (1),
Li₃₊ₐ₋ₑE_{1-b}G_{b}D_{c}X_{d-e} (1)
where, in Formula (1),
E is at least one element selected from the group consisting of Al, Sc, Y, Zr, Hf, and lanthanoids,
G is at least one element selected from the group consisting of Na, K, Rb, Cs, Mg, Ca, Sr, Ba, B, Si, Al, Ti, Cu, Sc, Y, Zr, Nb, Ag, In, Sn, Sb, Hf, Ta, W, Au, and Bi,
D is at least one selected from the group consisting of CO₃, SO₄, BO₃, PO₄, NO₃, SiO₃, OH, and O₂,
X is at least one element selected from the group consisting of F, Cl, Br, and I, and
when n=(valence of E)−(valence of G), a=nb, 0≤b<0.5, 0≤c≤5, 0≤d≤7.1, 0≤e≤2, and 0<d-e are satisfied, and
a dew point in the housing step is set to be lower than −20° C. and −90° C. or higher.
